(19) United States
(12) Patent Application Publication
(10) Pub. No.: US 2009/0197523 A1
(43) Pub. Date: Aug. 6, 2009

(54) METHOD AND SYSTEM FOR PROVIDING PAID CONTENTS IN A PORTABLE BROADCASTING SERVICE

(75) Inventors: Jeong-Mi Seok, Suwon-si (KR); Young-Jip Kim, Suwon-si (KR); Joon-Ho Park, Suwon-si (KR); Ki-Yeon Sung, Seoul (KR); Kyung-Shin Lee, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/366,294

(22) Filed: Feb. 5, 2009

(30) Foreign Application Priority Data
Feb. 5, 2008 (KR) 10-2008-0011991

(51) Int. Cl. H04H 20/71; H04N 7/173

(52) U.S. Cl. 455/3.01; 725/86

(57) ABSTRACT

A method and system for providing paid service contents in a portable broadcasting service are provided, in which a first broadcasting-receiving terminal requests service purchase by indicating paid contents to be purchased and designating a service consumer to receive the paid contents, and a broadcasting server provides the paid contents to a second broadcasting-receiving terminal corresponding to the service consumer when the purchase of the paid contents is successful.

### PRIORITY

This application claims priority under 35 U.S.C. §119(a) to a Korean Patent Application filed in the Korean Intellectual Property Office on Feb. 5, 2008 and assigned Serial No. 2008-11991, the disclosure of which is hereby incorporated by reference.

### BACKGROUND OF THE INVENTION

1. Field of the Invention

The present invention generally relates to a method and system for providing paid contents in a mobile broadcasting service. More particularly, the present invention relates to a method and system for providing paid contents when the purchaser is different from the user.

2. Description of the Related Art

The mobile communication market is facing an ever-increasing demand for creation of new services through re-combination or convergence of existing technologies. Today's development of communications and broadcasting technology has driven legacy broadcasting systems or legacy mobile communication systems to the point that they provide a portable broadcasting service through a portable terminal, such as a hand-held phone, a Personal Digital Assistant (PDA), etc., referred to herein as a mobile terminal. Owing to an entanglement of these potential and actual market demands, increasing user demands for multimedia service, and service providers' strategies for providing new services in addition to the traditional voice service, and Information Technology (IT) companies' interest in reinforcing their mobile communication business, convergence between mobile communication service and Internet Protocol (IP) has become a great trend in developing future-generation mobile communication technologies. Also, commercialization and standardization of a portable broadcasting service that provides a broadcasting service to mobile terminals is actively under way.

For example, a commercial service based on Digital Video Broadcast-Handheld Convergence of Broadcast and Mobile Services (DVB-H CBMS) is already going on in Italy. Vietnam is providing a commercial service in compliance with Nokia-Open Air Interface (OAI) standards. Other than those, there are many portable broadcasting service standards including S/T Digital Multimedia Broadcasting (S/T-DMB), MediaFLo, DVB-Satellite services to Handheld (DVB-SH), and Open Mobile Alliance Mobile Broadcast (OMA-BCAST). Among the various standards, DVB-H CBMS, DVB-SH, Nokia-OAI, and OMA-BCAST use a DVB-H network as a lower transmitting end.

A television (TV) broadcasting service is provided to mobile terminals across a wide area in the portable broadcasting service. A portable broadcasting service is an extension of an existing TV service, added with mobility, and provides user-friendly, useful, and value-added services including Web broadcasting, gaming, software distribution, etc., in addition to TV broadcasting. Various service contents are fee based, referred to herein as a paid service, e.g. they require some type of payment arrangement prior to service content access.

A general procedure for providing a paid service to broadcasting-receiving terminals supporting BCAST Smart Card Profile (BCAST SCP) is illustrated in FIG. 1.

Referring to FIG. 1, a broadcasting-receiving terminal 10 requests service purchase by transmitting a Service Request message including the Identifier (ID) of desired service contents to a broadcasting server 20 in step 31. The broadcasting server 20 transmits a Service Response message including information indicating purchase success or purchase failure to the broadcasting-receiving terminal 10 in step 33. In the case of purchase success, the service contents are charged. When a TV application is executed or power is on, the broadcasting-receiving terminal 10 should register to the broadcasting server 20 in relation to the purchased service content. The reason for the registration is for the broadcasting-receiving terminal 10 to notify the broadcasting server 20 that the terminal 10 is ready to receive a service key in the User Datagram Protocol (UDP).

Therefore, the broadcasting-receiving terminal 10 requests service registration to the broadcasting server 20 by a Registration Request message including the IDs of all service contents purchased currently in step 35. The broadcasting server 20 registers the purchased service contents according to the request of the broadcasting-receiving terminal 10 and transmits a Registration Response message to the broadcasting-receiving terminal 10 in step 37. In step 39, the broadcasting server 20 transmits an updated service key by the UDP to the broadcasting-receiving terminal 10 each time the service key is updated while the broadcasting-receiving terminal 10 is registered. The service key is needed for the broadcasting-receiving terminal 10 to reproduce the purchased service contents.

When the broadcasting-receiving terminal 10 fails to receive a necessary service key in an exceptional case, the terminal 10 can request the service key to the broadcasting server 20. That is, the broadcasting-receiving terminal 10 transmits a Multimedia Broadcast/Multicast Service (MBMS) Service Key (MSK) Request message including the ID of the service key to the broadcasting server 20. The broadcasting server 20 then replies with an MSK Response message. An MSK, i.e. an MBS Service Key is transmitted in the form of a Multimedia Internet KEYing (MIKEY).

In step 41, when the TV application ends or power is off, the broadcasting-receiving terminal 10 requests service deregistration by transmitting a Deregistration Request message to the broadcasting server 20. This means that the broadcasting-receiving terminal 10 does not need to receive the MSK from the broadcasting server 20 any longer. The Deregistration Request message includes the IDs of all service contents which were registered successfully in steps 35 and 37.

In the above conventional paid service, however, a purchaser of service contents and an actual consumer of the service contents cannot be distinguished from each other and accordingly, the different purchaser and consumer cannot be notified to the broadcasting server 20. As a consequence, the service contents are accessible only to the purchaser. That is, the purchased contents cannot be presented to another user.

### SUMMARY OF THE INVENTION

The present invention substantially solves at least the above-described problems and/or disadvantages and provides at least the advantages described below. Accordingly, an aspect of the present invention is to provide a method and apparatus for providing contents in such a manner that a user other than a purchaser can enjoy purchased service contents in a portable broadcasting service.

Moreover, an aspect of the present invention provides a method and apparatus for enabling a purchaser of service contents to donate them to another user in a portable broadcasting service.

In accordance with an aspect of the present invention, there is provided a method for providing paid service contents in a portable broadcasting service, in which a first broadcasting-receiving terminal requests service purchase by indicating paid contents to be purchased and designating a service consumer to receive the paid contents, and a broadcasting server provides the paid contents to a second broadcasting-receiving terminal corresponding to the service consumer when the purchase of the paid contents is successful.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a signal flow for a conventional operation for providing paid service contents;

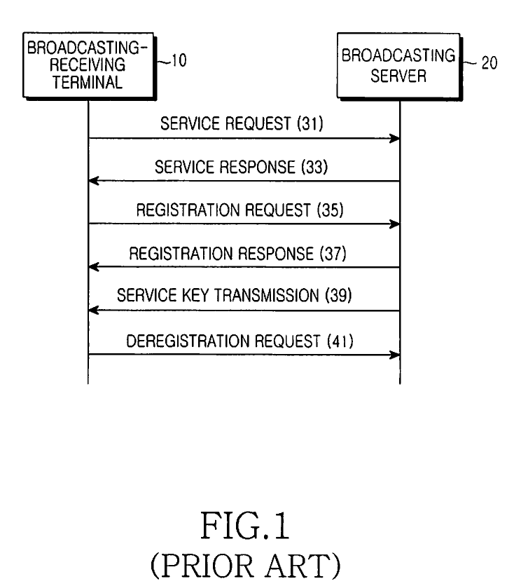

FIG. 2 illustrates the configuration of a portable broadcasting system to which the present invention is applied; and

FIG. 3 is a diagram illustrating a signal flow for an operation for providing paid service contents according to the present invention.

Throughout the drawings, the same drawing reference numerals will be understood to refer to the same elements, features and structures.

### DETAILED DESCRIPTION OF THE PREFERRED EMBODIMENTS

The matters defined in the description such as a detailed construction and elements are provided to assist in a comprehensive understanding of preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

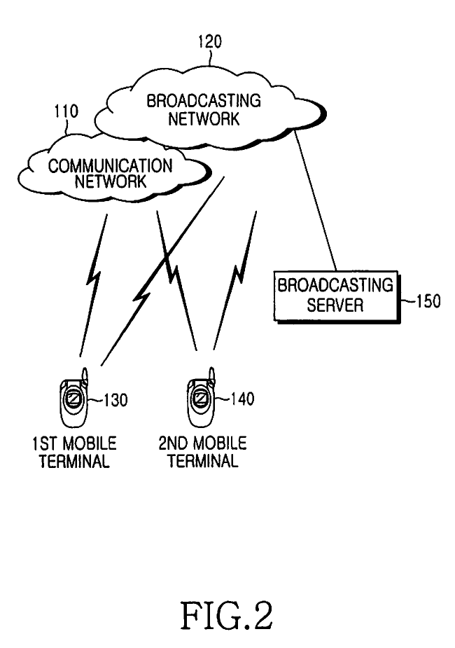

With reference to FIG. 2, a configuration of a portable broadcasting system to which the present invention is applied will now be described.

The portable broadcasting system of FIG. 2 includes a communication network 110, a broadcasting network 120, a first broadcasting-receiving terminal 130, a second broadcasting-receiving terminal 140, and a broadcasting server 150.

A wired communication service, a mobile communication service, and broadcasting services based on a portable broadcasting service are provided over the communication network 110. A broadcasting service based on the portable broadcasting service is provided over the broadcasting network 120.

The broadcasting server 150 transmits various broadcasting contents and broadcasting guide information to the broadcasting-receiving terminals 130 and 140 according to portable broadcasting service standards over the communication network 110 and the broadcasting network 120. According to the present invention, when the broadcasting-receiving terminals 130 and 140 request purchase of paid service contents over the communication network 110, the broadcasting server 150 determines whether the requesting terminals 130 and 140 have designated service consumers. The service consumers refer to users to receive the paid service contents other than users that have purchased the paid service contents. If particular users are designated as the service consumers in the service purchase request, the broadcasting server 150 notifies the broadcasting-receiving terminals of the designated users that they can receive the paid service contents and provides the paid service contents to them.

The broadcasting-receiving terminals 130 and 140 can be portable terminals, such as hand-held phones, Personal Digital Assistants (PDAs), etc. They provide a portable broadcasting service received over the communication network 110 and the broadcasting network 120 to users and a communication service like a mobile communication service to the users. The broadcasting-receiving terminals 130 and 140 can purchase paid service contents and designate particular users as service consumers of the paid service contents according to the exemplary embodiment of the present invention. If the broadcasting-receiving terminals 130 and 140 are designated as service consumers by other users, they are notified that they will receive paid service contents by the broadcasting server 150 and receive them from the broadcasting server 150.

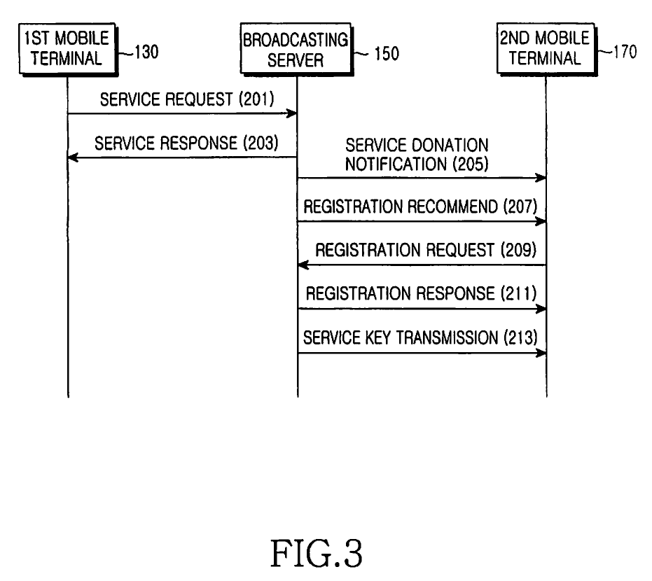

For better understanding of the present invention that distinguishes a purchaser of service contents from a consumer of the service contents in the above portable broadcasting system, the first broadcasting-receiving terminal 130 is assumed to be a terminal of a purchaser of paid service contents and the second broadcasting-receiving terminal 140 is a terminal of a service consumer to receive the paid service contents, designated by the first broadcasting-receiving terminal 130. With reference to FIG. 3, an operation for purchasing paid service contents and providing the paid service contents to a designated service consumer in a portable broadcasting system according to the present invention will now be described.

The first broadcasting-receiving terminal 130 of FIG. 3 requests service purchase to the broadcasting server 150 by a Service Request message with a particular service consumer set in step 201. The Service Request message includes a user ID allocated to a user designated as the service consumer according to the exemplary embodiment of the present invention. A user ID is allocated to the user of each broadcasting-receiving terminal. For example, a user ID can be a telephone number. According to the present invention, the user ID corresponding to the service consumer can be included in the Service Request message only when the service purchaser designates the service consumer.

Therefore, to include the user ID corresponding to the service consumer in the Service Request message, a new sting-type field GiftUserID can be added according to the present invention, GiftUserID is an example of a new element used to include the user ID corresponding to the service consumer. The new element can be any element of any type with any name. For convenience' sake, GiftUserID is take as an example.

GiftUserID has an attribute of an unsignedByte type. When a purchaser purchases paid service contents to give them to another user as a present, the GiftUserID element indicates the user ID value of the service consumer to receive the paid service contents as a present. The type attribute of GiftUserID indicates the type of the user ID indicated by GiftUserID, as defined in Table 1 for example. Referring to Table 1, if GiftUserID is set to a phone number of the service consumer, the type attribute value of GiftUserID can be 0.

TABLE 1

| Type attribute value | Type |
|---|---|
| 0 | Phone number |
| 1-127 | Reserved for future use |
| 128-255 | Reserved for proprietary user |

In accordance with the present invention, since the GiftUserID element is included in the Service Request message only if a purchaser of paid service contents designates a service consumer to receive the paid service contents as a present, the broadcasting server 150 can determine whether the current purchase of the paid service contents is to be donated from the presence or absence of GiftUserID. Table 2 below illustrates part of an xml schema of the Service Request message when GiftUserID is added and Table 3 illustrates a schema including the type attribute of GiftUserID defined in Table 2.

TABLE 2

```
<xs:element name=“ServiceRequest” type=“ServiceRequestType”/>
  <xs:complexType name=“ServiceRequestType”>
    <xs:sequence>
      <xs:element name=“UserID” type=“UserIDType” minOccurs=“0”
maxOccurs=“unbounded”/>
      <xs:element name=“DeviceID” type=“DeviceIDType” minOccurs=“0”
maxOccurs=“unbounded”/>
      <xs:element name=“GiftUserID” type=“GiftUserIDType” minOccurs=“0”
maxOccurs=“unbounded”/>
      <xs:element name=“ServiceEncryptionProtocol” type=“xs:string”
minOccurs=“0”/>
      <xs:element name=“PurchaseItem” maxOccurs=“unbounded”>
        <xs:complexType>
          <xs:sequence>
            <xs:element name=“PurchaseDataReference”
type=“PurchaseDataReferenceType” minOccurs=“0” maxOccurs=“unbounded”/>
            <xs:element name=“UserConsentAnswer”
type=“UserConsentAnswerType”/>
            <xs:element name=“Service” type=“ServiceType” minOccurs=“0”
maxOccurs=“unbounded”/>
          </xs:sequence>
          <xs:attribute name=“globalIDRef” type=“xs:anyURI” use=“required”/>
        </xs:complexType>
      </xs:element>
      <xs:choice>
        <xs:element name=“DrmProfileSpecificPart” minOccurs=“0”>
          <xs:complexType>
            <xs:sequence>
              <xs:element name=“BroadcastMode” type=“xs:boolean”
minOccurs=“0”/>
            </xs:sequence>
            <xs:attribute name=“rightsIssuerURI” type=“xs:anyURI”
use=“optional”/>
          </xs:complexType>
        </xs:element>
        <xs:element name=“SmartcardProfileSpecificPart” minOccurs=“0”>
          <xs:complexType>
            <xs:sequence>
              <xs:element name=“ProtectionKeyID” type=“xs:unsignedLong” minOccurs=
“1” maxOccurs=“unbounded”/>
            </xs:sequence>
            <xs:attribute name=“timestampMin” type=“xs:hexBinary”
use=“optional”/>
            <xs:attribute name=“timestampMax” type=“xs:hexBinary”
use=“optional”/>
          </xs:complexType>
        </xs:element>
      </xs:choice>
    </xs:sequence>
    <xs:attribute name=“requestID” type=“xs:unsignedInt” use=“optional”/>
  </xs:complexType>
  <!--
```

TABLE 3

```
<!--
  Type of Gift User ID:
  0 - Phone Number
  1-127 reserved for future use
  128-255 reserved for proprietary use
  -->
  <xs:simpleType name=“GiftUserIDTypeType”>
    <xs:union
memberTypes=“GiftUserIDLRType
ReservedProprietaryExtByteRangeType”/>
  </xs:simpleType>
  <xs:simpleType name=“GiftUserIDLRType”>
    <xs:restriction base=“xs:unsignedByte”>
      <xs:minInclusive value=“0”/>
      <xs:maxInclusive value=“0”/>
    </xs:restriction>
  </xs:simpleType>
```

Referring to FIG. 3 again, upon receipt of the Service Request message, the broadcasting server 150 identifies the paid service contents to be purchased and determines whether a service consumer is designated by analyzing the Service Request message in step 201. If a service consumer is designated in the Service Request message, the broadcasting server 150 determines whether the terminal of the service consumer can process the paid service and transmits a Service Response message indicating whether the paid service can be processed or not to the first broadcasting-receiving terminal 130 in step 203. That is, if the terminal of the service consumer can process the paid service, the broadcasting server 150 transmits a code indicating successful service purchase in the Service Response message. If the terminal of the service consumer cannot process the paid service, the broadcasting server 150 transmits a code indicating failed service purchase in the Service Response message. In the latter case, the transmitted code can be Global status code 30. Global status code 30 can be designated as shown in Table 4 and can be expressed as the schema illustrated in Table 5. Referring to Table 4, for example, Global status code 30 indicates BCAST SCP Not Supported, which indicates that the terminal of the service consumer is not capable of processing the paid service. Any other Global status code value can be set to indicate a terminal that cannot process a paid service.

TABLE 4

| | |
|---|---|
| Global status code 30 | BCAST SCP Not Supported |
| | This is transmitted when the terminal of the |
| | service consumer does not support the paid |
| | service |

TABLE 5

```
<!--
    Global status codes
      0 - 30 defined in OMA-TS-BCAST Services-V1 0
      31 -127 reserved for future use
      128 - 255 reserved for proprietary use
  -->
  <xs:simpleType name=“GlobalStatusCodeType”>
    <xs:union memberTypes=“GlobalStatusCodeLRType
ReservedProprietaryExtByteRangeType”/>
  </xs:simpleType>
  <xs:simpleType name=“GlobalStatusCodeLRType”>
    <xs:restriction base=“xs:unsignedByte”>
      <xs:minInclusive value=“0”/>
      <xs:maxInclusive value=“30”/>
    </xs:restriction>
```

In accordance with the present invention illustrated in FIG. 3, the first broadcasting-receiving terminal 130 designates the user of the second broadcasting-receiving terminal 140 as the service consumer of the paid service contents when requesting the service purchase in step 201. Hence, the broadcasting server 150 determines whether the second broadcasting-receiving terminal 140 can execute the paid service or process the paid service contents. If the second broadcasting-receiving terminal 140 is capable of processing the paid service, the broadcasting server 150 notifies the first broadcasting-receiving terminal 130 of successful service purchase in step 203 and notifies the terminal of the service consumer, i.e. the second broadcasting-receiving terminal 140, that the terminal 140 will receive the paid service contents, that is, the paid service contents are donated to the terminal 140 in step 205. The service donation notification can be made by a short message.

In step 207, the broadcasting server 150 prompts the second broadcasting-receiving terminal 140 to perform service registration by a Registration WAP message. Herein, the broadcasting server 150 sets a Key Group Part and a Key Number Part of an MSK ID to 1 and 0, respectively in the Registration WAP message. The second broadcasting-receiving terminal 140 requests service registration to the broadcasting server 150 by a Registration Request message indicating that the terminal 140 will register all paid services available to the second broadcasting-receiving terminal 140 in step 209. The broadcasting server 150 registers the donated paid service contents and transmits a Registration Response message to the second broadcasting-receiving terminal 140 in step 211. In step 213, the broadcasting server 150 transmits an updated service key to the second broadcasting-receiving terminal 140 each time the service key is updated, while the second broadcasting-receiving terminal 140 is registered.

As is apparent from the above description, the present invention advantageously enables a user other than a user that purchases service contents and pays for them to consume the service contents in a portable broadcasting service. Therefore, the purchaser can donate his purchased service contents to another user.

While the invention has been shown and described with reference to certain preferred embodiments of the present invention thereof, it will be understood by those skilled in the art that various changes in form and details may be made therein without departing from the spirit and scope of the present invention as defined by the appended claims and their equivalents.

What is claimed is:

1. A method for providing paid service contents in a portable broadcasting service, the method comprising:
requesting service purchase by indicating paid contents to be purchased and designating a service consumer to receive the paid contents by a first broadcasting-receiving terminal; and
providing the paid contents to a second broadcasting-receiving terminal corresponding to the service consumer by a broadcasting server when the purchase of the paid contents is successful.

2. The method of claim 1, wherein providing the paid contents comprises:
determining whether the service consumer is designated in the service purchase request;
determining whether the second broadcasting-receiving terminal is capable of processing the paid contents when the service consumer is designated;
notifying the first broadcasting-receiving terminal of successful purchase of the paid contents when the second broadcasting-receiving terminal is capable of processing the paid contents;
notifying the second broadcasting-receiving terminal of the presence of the paid contents to be received; and
providing the paid contents to the second broadcasting-receiving terminal, upon receipt of a service registration request from the second broadcasting-receiving terminal.

3. The method of claim 2, wherein providing the paid contents further comprises notifying the first broadcasting-receiving terminal of failed purchase of the paid contents when the second broadcasting-receiving terminal is not capable of processing the paid contents.

4. The method of claim 3, wherein the service purchase requesting comprises transmitting a service request message including a user Identifier (ID) of the service consumer.

5. A system for providing paid service contents in a portable broadcasting service, the system comprising:
a first broadcasting-receiving terminal for requesting service purchase by indicating paid contents to be purchased and designating a service consumer to receive the paid contents; and
a broadcasting server for providing the paid contents to a second broadcasting-receiving terminal corresponding to the service consumer when the purchase of the paid contents is successful.

6. The system of claim 5, wherein the broadcasting server is configured to determine whether the service consumer is designated in the service purchase request, determine whether the second broadcasting-receiving terminal is capable of processing the paid contents when the service consumer is designated, notify the first broadcasting-receiving terminal of successful purchase of the paid contents when the second broadcasting-receiving terminal is capable of processing the paid contents, notify the second broadcasting-receiving terminal of the presence of the paid contents to be received, and provide the paid contents to the second broadcasting-receiving terminal, upon receipt of a service registration request from the second broadcasting-receiving terminal.

7. The system of claim 6, wherein the broadcasting server is configured to notify the first broadcasting-receiving terminal of failed purchase of the paid contents when the second broadcasting-receiving terminal is not capable of processing the paid contents.

8. The system of claim 7, wherein the first broadcasting receiver transmits a service request message including a user Identifier (ID) of the service consumer.
